(19) United States
(12) Patent Application Publication
(10) Pub. No.: US 2016/0224582 A1
(43) Pub. Date: Aug. 4, 2016

(54) DATA PROCESSING METHOD AND DATA PROCESSING SERVER

(71) Applicant: HITACHI, LTD., Tokyo (JP)

(72) Inventors: Daisuke KITOU, Tokyo (JP); Kei KITAHARA, Tokyo (JP); Naoki SHIMOTSUMA, Tokyo (JP); Dan YAMAMOTO, Tokyo (JP); Satoshi YASHIRO, Tokyo (JP); Kazuhiro FURUTA, Tokyo (JP)

(73) Assignee: Hitachi, Ltd., Tokyo (JP)

(21) Appl. No.: 15/022,220

(22) PCT Filed: Oct. 29, 2014
(86) PCT No.: PCT/JP2014/078682

§ 371 Date: Mar. 16, 2016

(30) Foreign Application Priority Data
Dec. 10, 2013 (JP) 2013-254626

(51) Int. Cl. G06F 17/30; H04L 29/08

(52) U.S. Cl. CPC G06F 17/30115; H04L 67/06

(57) ABSTRACT

According to a data processing method, pieces of data from files having dissimilar file structures and different formats can be combined appropriately for processing, and even a user with little knowledge can easily combine and process data. The method comprising: receiving, from a user terminal, designation of a first file and a second file, and a request to execute data processing that is related to a particular function; obtaining the first file and the second file from a memory unit; analyzing structures of the first file and the second file; combining, when there is a first element set in the first file as many elements as in a second element set the second file has, the elements of the first element set with the elements of the second element set to execute the data processing; and transmitting a result of executing the data processing to the user terminal.

### BACKGROUND OF THE INVENTION

This invention relates to a technology of combining a plurality of files in an appropriate manner to process data.

The amount of data generated in companies and social activities is increasing explosively in recent years. On the other hand, the progress in information and communication technology is making it easier to collect, accumulate, analyze, and otherwise process a large amount of data. The expectation for the creation of new services that utilize public data as one of various and diverse types of data is also increasing lately. Under the above-mentioned backgrounds, governments are attempting to make improvements such as increasing the transparency of the organizations and increasing the quality of public service by opening access to public data and thus facilitating the reutilization of public data by the private sector. A service which is configured to allow a user to find out in real time the availability status of shared bicycles for rent in town is given as an example of services utilizing public data. While beneficial services such as the one described above can be realized by the publication and utilization of public data, there are issues in handling public data, such as the lack of information about which data is stored where, low user-friendliness, and a difficulty in determining how those various and diverse types of data are to be combined for processing.

Known technologies of combining a plurality of pieces of data for processing include JP 4,992,072 B2 and JP 4,878,624 B2. In JP 4,992,072 B2, partial files created by dividing a plurality of files are combined to form a pair. Specifically, each file is broken into subtrees of an appropriate size, and whether to pair a subtree of one file with a subtree of another file is determined based on the degree of similarity in leaf node between the subtrees (the proportion of the number of identical leaf nodes to the total number of leaf nodes). In JP 4,878,624 B2, the degree of similarity in tag structure (the parent-child relationship, the sibling relationship, and the like) between files is used to determine which files are to be paired with each other.

The known technologies described above are suitable for combining and processing files that have a high degree of similarity in content such as leaf nodes or tag structures, but have difficulties in combining and processing other types of files. Another problem is that files that have different formats cannot be combined and processed with those technologies.

### SUMMARY OF THE INVENTION

In view of the above, it is an object of this invention to provide a data processing method with which pieces of data from files having dissimilar file structures or from files having different formats can be combined and processed, and the combining and processing of data can be executed easily even by a user with little knowledge in the art, and a data processing server configured to execute the data processing method.

A representative example of this invention comprising: a memory unit configured to store a plurality of files; and a processor configured to: receive, from a user terminal, designation of a first file and a second file, and a request to execute data processing that is related to a particular function; obtain the designated first file and the designated second file from the memory unit; analyze structures of the obtained first file and the obtained second file; combine, when there is a first element set in the first file as many elements as in a second element set the second file has, the elements of the first element set with the elements of the second element set to execute the data processing; and transmit a result of executing the data processing to the user terminal.

According to this invention, pieces of data from files having dissimilar file structures and from files having different formats can be combined in an appropriate manner for processing, and the combining and processing of data can be executed easily even by a user with little knowledge in the art.

### BRIEF DESCRIPTION OF THE DRAWINGS

FIG. 1 is a block diagram for illustrating an example of a hardware configuration and a software configuration of a data processing system according to a first embodiment of this invention.

FIG. 2A is an explanatory diagram for illustrating an example of published public data (Kanagawa Prefecture population information) in the first embodiment of this invention.

FIG. 2B is an explanatory diagram for illustrating another example of published public data (city hall location information) in the first embodiment of this invention.

FIG. 2C is an explanatory diagram for illustrating still another example of published public data (prefecture border information) in the first embodiment of this invention.

FIG. 3 is an explanatory diagram for illustrating an example of a method of combining data from one file with data from another file according to the first embodiment of this invention.

FIG. 4 is a diagram for illustrating an example of data combination information 111 according to the first embodiment of this invention.

FIG. 5 is a diagram for illustrating an example of data source information 112 according to the first embodiment of this invention.

FIG. 6 is a diagram for illustrating an example of combination history information 113 according to the first embodiment of this invention.

FIG. 7 is a flow chart for illustrating an example of processing that is executed with respect to basic data combining (pair forming) by a data processing server 101 according to the first embodiment of this invention.

FIG. 8 is a flow chart for illustrating an example of processing that is executed with respect to data combination inference by the data processing server 101 according to the first embodiment of this invention.

FIG. 9 is a flow chart for illustrating an example of processing that is executed with respect to data combining based on user association by the data processing server 101 according to the first embodiment of this invention.

FIG. 10 is a flow chart for illustrating an example of processing that is executed with respect to the registration of the data combination information 111 by the data processing server 101 according to the first embodiment of this invention.

FIG. 11 is a flow chart for illustrating an example of processing that is executed with respect to the obtainment of related data by the data processing server 101 according to the first embodiment of this invention.

FIG. 12 is a flow chart for illustrating an example of processing that is executed with respect to data processing in the middle of data input by the data processing server 101 according to a second embodiment of this invention.

FIG. 13 is an explanatory diagram for illustrating an example of a method of designating data input to the data processing server 101 according to the second embodiment of this invention.

### DETAILED DESCRIPTION OF THE PREFERRED EMBODIMENTS

Embodiments of this invention are described below. The embodiments described below are given as examples, and are not to limit this invention.

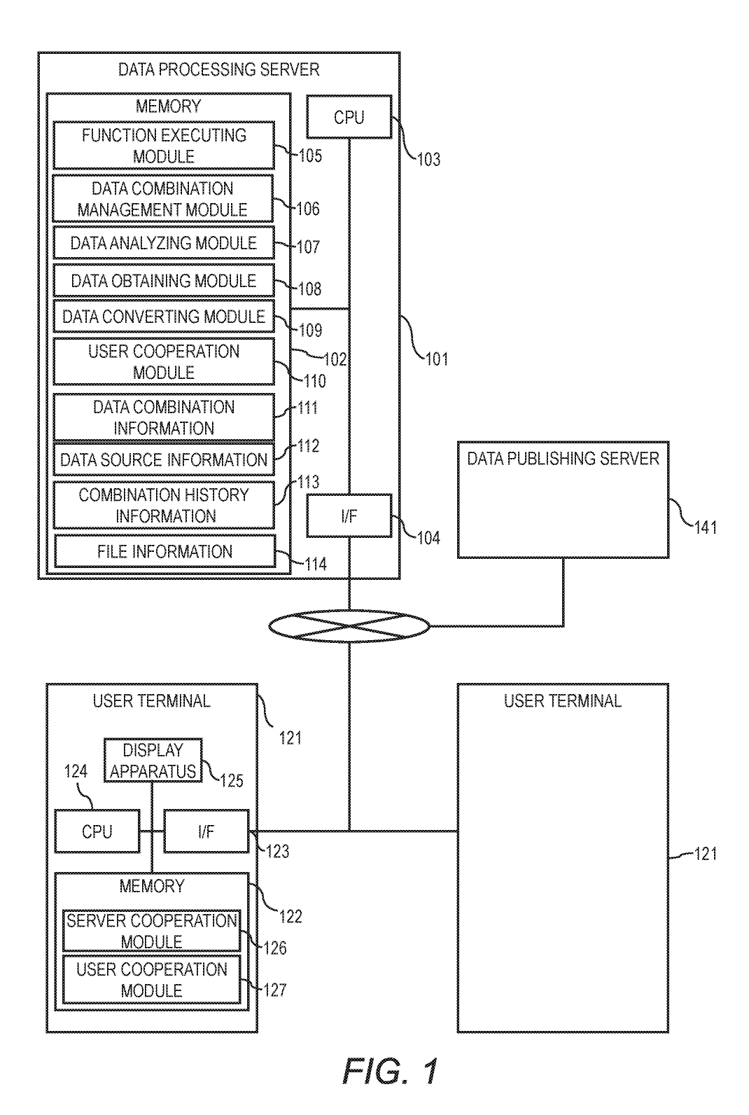

A first embodiment of this invention is described with reference to FIG. 1 to FIG. 11.

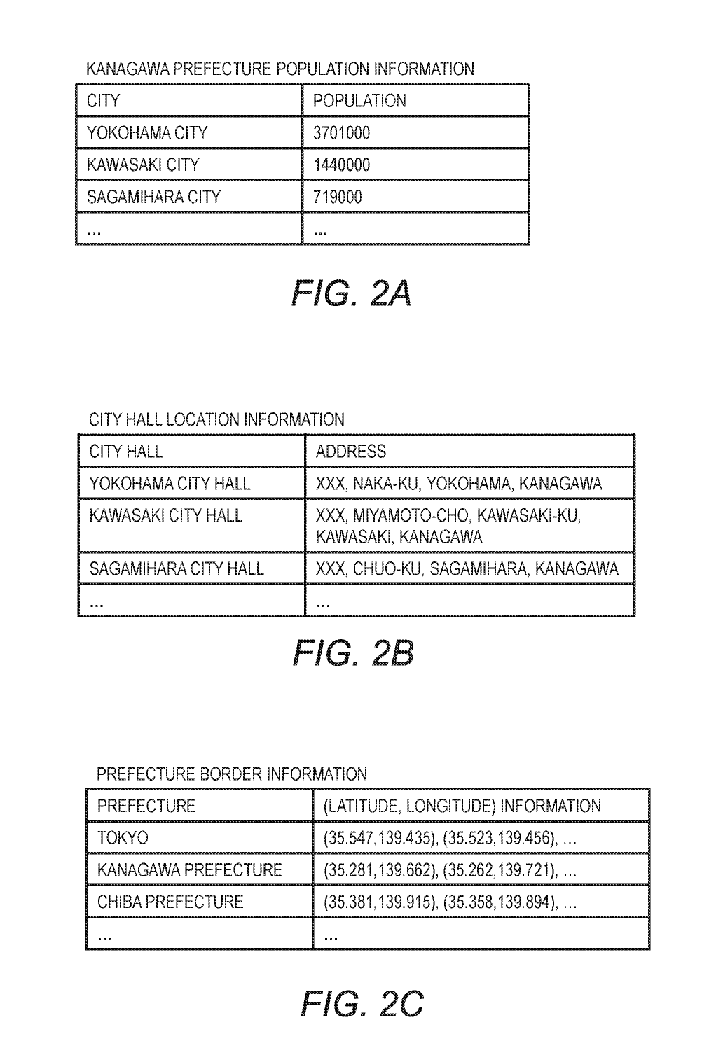

FIG. 1 is a block diagram for illustrating a hardware configuration and a software configuration of a data processing system according to the first embodiment of this invention. The data processing system includes at least one data processing server (data processing apparatus) 101, at least one data publishing server (data publishing apparatus) 141, and at least one user terminal (computer) 121. The data publishing servers are servers configured to hold various types of data and to publish the data to general public, and are intended for use by citizens, businesses specialized in data processing, and the like in providing new services. Examples of data to be published include public data, such as prefecture map information and information on schools, city halls, and other public institutions, and results of processing those pieces of the public data on one's own. FIG. 2A to FIG. 2C are diagrams for illustrating examples of published public data in the first embodiment of this invention. The examples of published public data illustrated in FIG. 2A, FIG. 2B, and FIG. 2C are Kanagawa Prefecture population information, city hall location information, and prefecture border information, respectively.

Each data processing server 101 and each user terminal 121 are coupled to a network via an interface (hereinafter abbreviated as I/F) 104 and an I/F 123, respectively. The data processing server 101 holds communication to and from external equipment, such as the user terminal 21, via the I/F 104 to receive a request to execute data processing that is related to a particular function, to send in response the result of executing the data processing, and the like.

Each data processing server 101 includes a central processing unit (CPU) 103, a memory (storage apparatus) 102, and the I/F 104. The CPU 103 executes, among others, the reception of a data processing execution request from external equipment, such as the user terminal 121, via the I/F 104, the requested data processing, and the transmission of the result of executing the data processing to the external equipment that has made the request. The memory 102 includes a function executing module 105, a data combination management module 106, a data analyzing module 107, a data obtaining module 108, a data converting module 109, a user cooperation module 110, data combination information 111, data source information 112, combination history information 113, and file information 114. The memory 102 is connected to the CPU 103 and the I/F 104. The function executing module 105, the data combination management module 106, the data analyzing module 107, the data obtaining module 108, the data converting module 109, and the user cooperation module 110 are programs executed by the CPU 103.

Each user terminal 121 includes a CPU 124, a memory 122, an I/F 123, and a display apparatus 125. The CPU 124 executes, among others, the transmission of a request to execute data processing that is related to a particular function to the data processing server 101 or the like via the I/F 123, and the reception of the execution result from the data processing server 101 or the like. The memory 122 includes a server cooperation module 126 and a user cooperation module 127, and is connected to the CPU 124 and the I/F 123. The server cooperation module 126 and the user cooperation module 127 are programs executed by the CPU 124. The display apparatus 125 displays, among others, the execution result received from the data processing server 101 or the like.

Described next are details of the software configuration (information stored in the memory 102 of the data processing server 101 and the memory 122 of the user terminal 121) of the data processing system according to this embodiment.

Other types of information than programs that are stored in the memory 102 of the data processing server 101 (the information 111 to the information 114) are described first, followed by a description on the programs (105 to 110) stored in the memory 102.

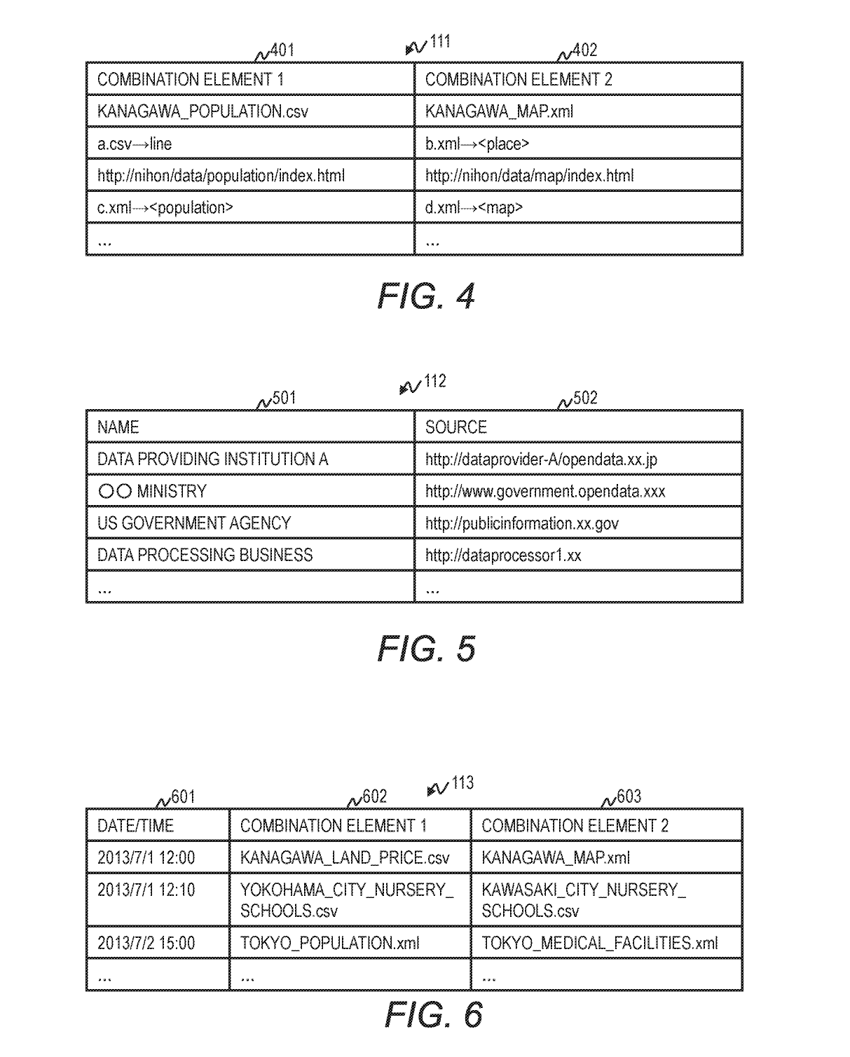

The data combination information 111 is information about combinations of data managed by the data processing server 101. FIG. 4 is a diagram for illustrating an example of the data combination information 111 according to the first embodiment of this invention. The data combination information 111 includes two data items, an item 401 and an item 402. The items 401 and 402 indicate information registered in the data processing server 101 as a candidate for data combinations. The data combination information 111 is used to, for example, determine whether or not a single piece of data (a file) designated by the user terminal is to be combined with another piece of data. In the example of FIG. 4, “Kanagawa_population.csv” and “Kanagawa_map.xml” are candidates for a combination, and an element in each line of “a.csv” and an element of a “b.xml” that has a <place> tag are candidates for a combination. Examples of other methods of designating a combination candidate than the one described above include designating a URL to combine pieces of data that are located at the designated URL as a combination candidate, and designating just a file format, instead of a file name, and designating elements of the designated format as a combination candidate. A combination candidate may be made up of three or more pieces of data.

The data source information 112 is information about sources from which the data processing server 101 obtains public data. FIG. 5 is a diagram for illustrating an example of the data source information 112 according to the first embodiment of this invention. The data source information 112 includes two data items, an item 501 and an item 502. The item 501 indicates the name of a data source. The item 502 indicates location information of the data source and is expressed in, for example, URL. For example, the fourth record in FIG. 5 indicates that the data processing server 101 can obtain data published by a data processing business from “http://dataprocessor1.xx”.

The combination history information 113 is history information about execution results of data combining processing that is executed in the past by the data processing server 101 in response to requests from the user terminal 121 or other triggers. FIG. 6 is a diagram for illustrating an example of the combination history information 113 according to the first embodiment of this invention. The combination history information 113 includes three data items, an item 601, an item 602, and an item 603. The item 601 indicates a date/time at which pieces of data are combined. The items 602 and 603 indicate the pieces of data combined. In the example of FIG. 6, data “Kanagawa_land_price.csv” and data “Kanagawa_map.xml” are combined to be processed at 12:00 on 2013 Jul . 1. Information used as the combination history information 113 may be other types of information than the one described above, for example, information indicating whether or not a data combination is appropriate. For instance, an inquiry is made via the user terminal 121 to the user about whether combining and processing pieces of data by a given processing program has yielded a desired result, i.e., whether the data has been processed properly by the given processing program to yield a meaningful result, and a response to the inquiry may additionally be stored as the combination history information 113 in the memory 102 or other places. This way, the history can be referred to later to find out which data combination yields a processing result that is useful.

The file information 114 is information about data, such as files stored in the memory 102 of the data processing server 101 or other places. The file information 114 indicates, for example, data obtained from the data publishing server 141 and storage data created by the user himself/herself.

The programs (105 to 110) stored in the memory 102 of the data processing server 101 are described next. The function executing module 105 executes processing based on various functions that are provided by the data processing server 101. Examples of the various functions include a function of displaying particular facilities on a map, and a function of keeping track of information of various modes of public transportation. The function executing module 105 executes data processing based on a request made by the user terminal 121 to execute data processing that is related to a particular function. A data input may be received prior to the execution of the data processing. The data combination management module 106 adds a new combination candidate to the data combination information 111, and removes a data combination candidate from the data combination information 111. Other tasks of the data combination management module 106 include determining which data is to be combined when the function executing module 105 executes processing. The data analyzing module 107 analyzes input data. In the case where an XML file is input, for example, the data analyzing module 107 performs an analysis such as an analysis of the structure of tags that make up the file. The data obtaining module 108 obtains data from the external equipment, such as the data publishing server 141. The data obtaining module 108 may obtain data in response to a request from the user terminal 121 or other triggers, or in time with the execution of processing by the function executing module 105. The data converting module 109 executes data conversion such as the conversion of an XML file into a CSV file. The user cooperation module 110 executes, among others, the reception of a data processing execution request from the user terminal 121 and the transmission of an execution result to the user terminal 121 in response to the request.

The information stored in the memory 122 of the user terminal 121 is described next. The server cooperation module 126 cooperates with an external server such as the data processing server 101 to transmit, to the external server, data that is input to the user terminal 121 and a data processing execution request. Examples of other tasks of the server cooperation module 126 include the reception of a result that is sent from the external server in response to the request. When the user operates the user terminal 121 for desired operation, the user cooperation module 127 receives operation information that is input as an operation request, and executes processing such as the execution of the operation requested by the user and the displaying of a result of the operation.

The hardware configuration and the software configuration of the data processing system in this embodiment have now been described. The description given next based on the described hardware configuration and the software configuration is about basic data combining processing, data combination inferring processing, data combining processing based on user association, data combination information registering processing, and related data obtaining processing in the first embodiment. The data combining processing and the data combination estimating processing are executed when, for example, the user terminal 121 transmits data and a data processing execution request to the data processing server 101. The data combination information registering processing is executed at arbitrary or particular timing, based on a request from the user terminal 121. Alternatively, the data processing server 101 determines when to execute the data combination information registering processing. The related data obtaining processing is executed based on a request from the user terminal 121, or executed automatically in time with the execution of data processing that is based on a particular function in the data processing server 101. Details of those processing procedures are given below.

### <Basic Data Combining Processing>

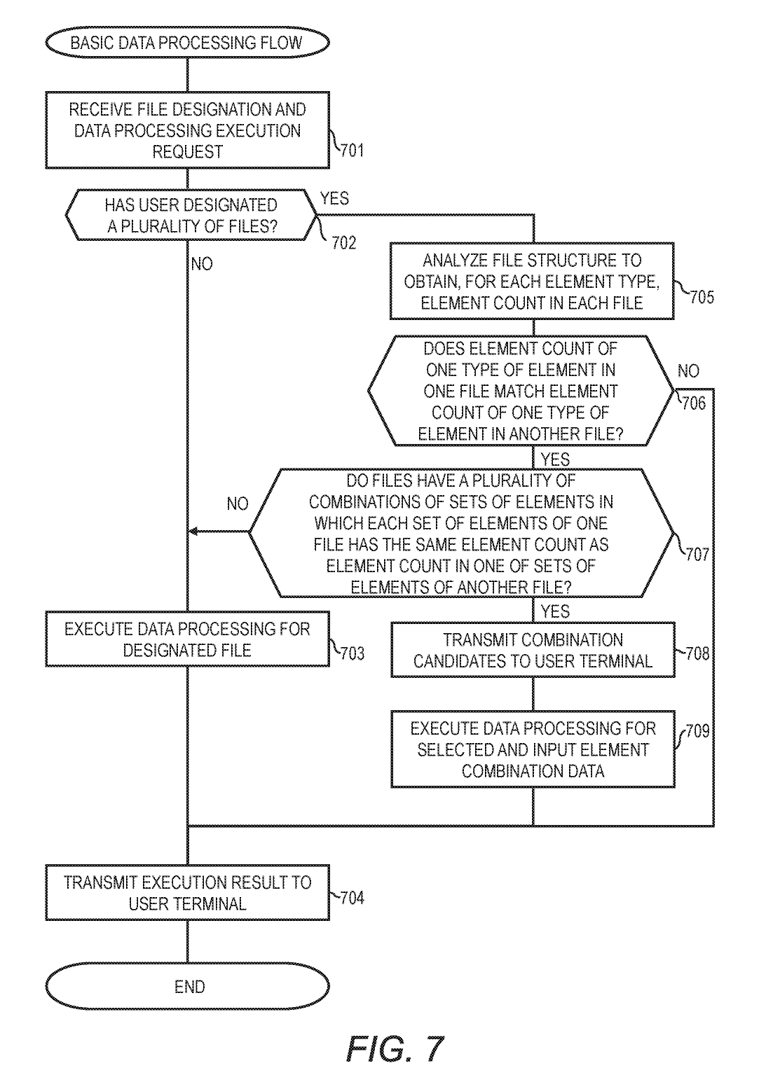

FIG. 7 is a flow chart for illustrating an example of basic data combining processing, which is executed by the data processing server 101 according to the first embodiment of this invention. First, the CPU 103 of the data processing server 101 receives from the user terminal 121 the designation of a plurality of files (input data) and a request to execute data processing that is related to a particular function (Step 701). For example, when the user operates the user terminal 121 to designate, as input data, a file a and a file b on the data processing server 101 and to issue an instruction to execute data processing that is related to a particular function, the CPU 103 of the data processing server 101 receives the designation of the file a and the file b as input data and the request to execute data processing that is related to a particular function. The CPU 103 next determines whether or not the user has designated a plurality of files (Step 702). In the case where the user has not designated a plurality of files (Step 702: NO), the CPU 103 executes the requested data processing for the designated file (Step 703), transmits the result of the execution to the user terminal 121 (Step 704), and ends the processing. In the case where the user has designated a plurality of files (Step 702: YES), the CPU 103 obtains the designated files from the memory 102 or other places, analyzes the structures of the files, and obtains for each file the number of elements that makes up the file (Step 705). The CPU 103 then determines whether or not one file and another file have the same number of identical or different elements (Step 706). When no two files meet the criterion (Step 706: NO), the CPU 103 transmits an execution result to the effect that combining and processing pieces of data are not executable to the user terminal 121, and ends the processing. On the other hand, in the case where there are files that meet the criterion of Step 706 (Step 706: YES), the CPU 103 determines whether or not the files include a plurality of such combinations of elements (Step 707). A specific example in which the designated files are “a.xml” and “b.xml” is described. In the case where the file “a.xml” has five <place> elements and the file “b.xml” has five <school> elements, for example, the CPU 103 determines in Step 706 that the files have the same number of elements. Further, in the case where the file “a.xml” has ten <place2> elements and the file “b.xml” has ten <station> elements, the CPU 103 determines in Step 707 that the files include a plurality of combinations of elements. In the case where the files do not include a plurality of combinations of elements (Step 707: NO), the CPU 103 combines the elements determined in Step 706 to execute the data processing requested by the user terminal 121 (Step 703), transmits the result of executing the processing to the user terminal 121 (Step 704), and ends the processing. In the case where the files include a plurality of combinations of elements (Step 707: YES), the CPU 103 transmits the combinations as element combination candidates to the user terminal 121 (Step 708). The CPU 124 of the user terminal 121 displays the element combination candidates received via the I/F 123 on the display apparatus 125. When, the user selects and inputs a desired element combination among the plurality of element combination candidates displayed on the display apparatus 125, the CPU 103 of the data processing server 101 receives the selected element combination data which is input from the user terminal 121, executes the data processing requested in Step 701 (Step 709), transmits the result of executing the data processing to the user terminal 121 (Step 704), and ends the processing.

An alternative to allowing the user to select and input an element combination candidate for processing in Step 708 is, for example, additionally registering, for each combination, information that indicates whether the combination is good or bad in the combination history information 113 in advance, and allowing the data processing server 101 to select an element combination that is evaluated highly in this information. The information indicating whether a combination is good or bad may be created by, for example, registering in the combination history information 113 an evaluation that is made by the user based on the result of executing data processing in Step 703. In the case where no two files have the same number of elements in Step 706, elements of one file that are to be combined may be padded (by adding elements having a null value or other methods) so as to match the number of particular elements of the other file, before undergoing the subsequent processing. When the file a and the file b have different numbers of elements, such as when the file a has fifty <big city> elements and the file b has a hundred <coast> elements, in the case where the <big city> elements and the <coast> elements include a common value, here, “Yokohama City”, processing of a combination of pieces of data is executable by, for example, combining data only for the common part. Thus, even when files have different numbers of elements to be combined, if the elements of one file and the elements of the other file have a common value, processing may be executed by combining data only for the part where the elements have a common value.

The data combination inferring processing according to the first embodiment of this invention is described next. Inferring a data combination candidate by referring to data (element) combination candidate information, which is registered in advance, and the past combination history information 113 enhances the precision of data combining and yields a more meaningful processing result.

### <Data Combination Inferring Processing>

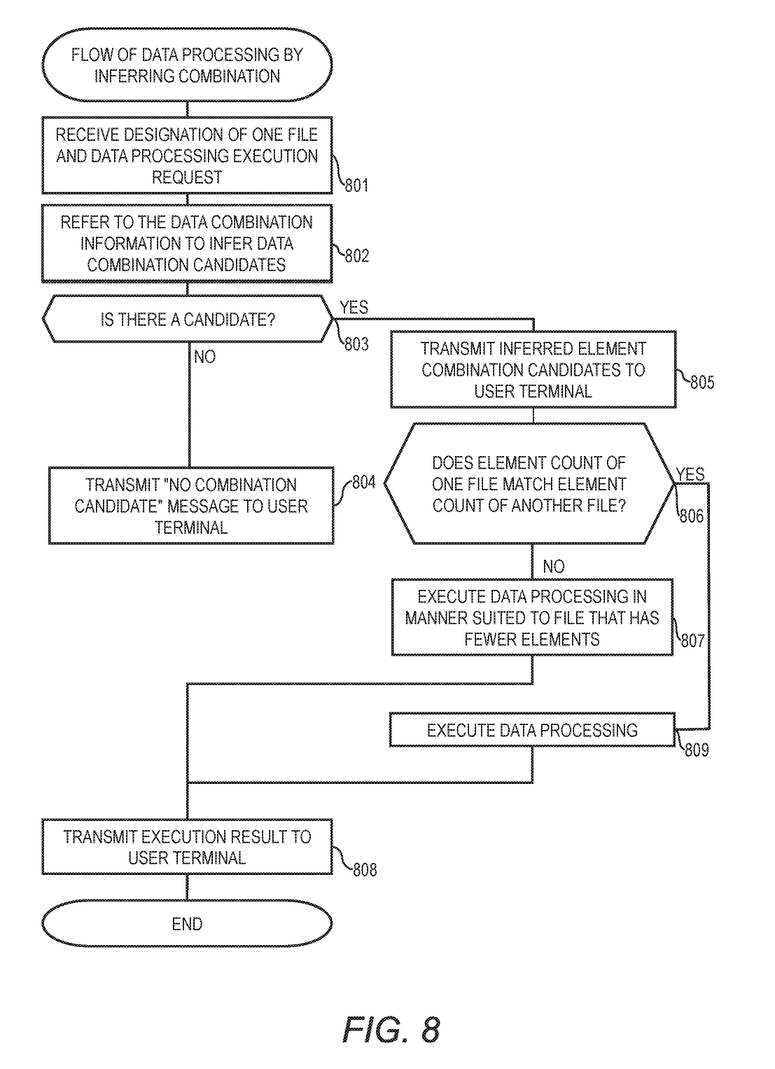

FIG. 8 is a flow chart for illustrating an example of data combination inferring processing, which is executed by the data processing server 101 according to the first embodiment of this invention. The processing described here is one that is executed by the CPU 103 of the data processing server 101 to infer data (element) combination candidates when it is determined in Step 702 of FIG. 7 that the user has not designated a plurality of files, by referring to the data combination information 111 (FIG. 4) on the memory 102. First, the CPU 103 of the data processing server 101 receives, from the user terminal 121, the designation of one file (input data) and a request to execute data processing that is related to a particular function (Step 801). The CPU 103 next refers to the data combination information 111 on the memory 102 to infer data combination candidates (Step 802). Specifically, the CPU 103 refers to the data combination information 111 illustrated in FIG. 4 to determine whether or not there is a file that can be combined with the designated file. When there is a file that can be combined, the CPU 103 infers this file data combination as a combination candidate. Other methods than this inferring method may be used. For example, whether or not there is a file that is often combined with the designated file may be determined by referring to the combination history information 113, to thereby set the combination of such a file and the designated file as a combination candidate. In the case where no combination candidate is found (Step 803: NO), the CPU 103 transmits a message to that effect to the user terminal 121 (Step 804) and ends the processing. When at least one combination candidate is found in Step 803 (Step 803: YES), the CPU 103 transmits the combination candidate to the user terminal 121 (Step 805). The combination candidate is displayed on the display apparatus 125 of the user terminal 121. When the user selects and inputs a desired combination candidate among the at least one combination candidate displayed on the display apparatus 125, the CPU 103 of the data processing server 101 analyzes the structures of the files of the selected and input combination to determine whether or not the files have the same number of elements (Step 806). For example, in the case where element combination information that contains a combination of <population> elements of a file “c.xml” and <map> elements of a file “d.xml” in the fourth record of the data combination information 111 (FIG. 4) is displayed as an element combination candidate on the display apparatus 125 of the user terminal 121, and the user selects and inputs the <population> elements and the <map> elements as a combination candidate, the CPU 103 of the data processing server 101 determines whether or not the number of <population> elements of the file “c.xml” which have been selected and input is the same as the number of <map> elements of the file “d.xml” which have been selected and input. In the case where the files have different numbers of elements (Step 806: NO), the CPU 103 executes the requested data processing in a manner suited to elements that are fewer in number of the compared sets of elements (Step 807), transmits the result of executing the data processing to the user terminal 121 (Step 808), and ends the processing. In the described example where there are ten <population> elements and twenty <map> elements, the requested data processing is executed for the ten elements, which are fewer. In the case where the files have the same number of elements (Step 806: YES), the CPU 103 executes the requested data processing (Step 809), transmits the result of executing the data processing to the user terminal 121, and ends the processing. Through the data combination inferring processing described above, the data processing server 101 is capable of inferring element combination candidates and displaying the candidates on the display apparatus 125 of the user terminal 121. Accordingly, even a user with little knowledge in how pieces of data are to be combined can operate the data processing system with ease.

The data combining processing based on user association in this embodiment is described next. This processing is assumed to be executed by a user with a certain degree of knowledge in how pieces of data are to be combined and in data structures, and is designed so that data combinations can be customized more freely.

### <Data Combining Processing Based on User Association>

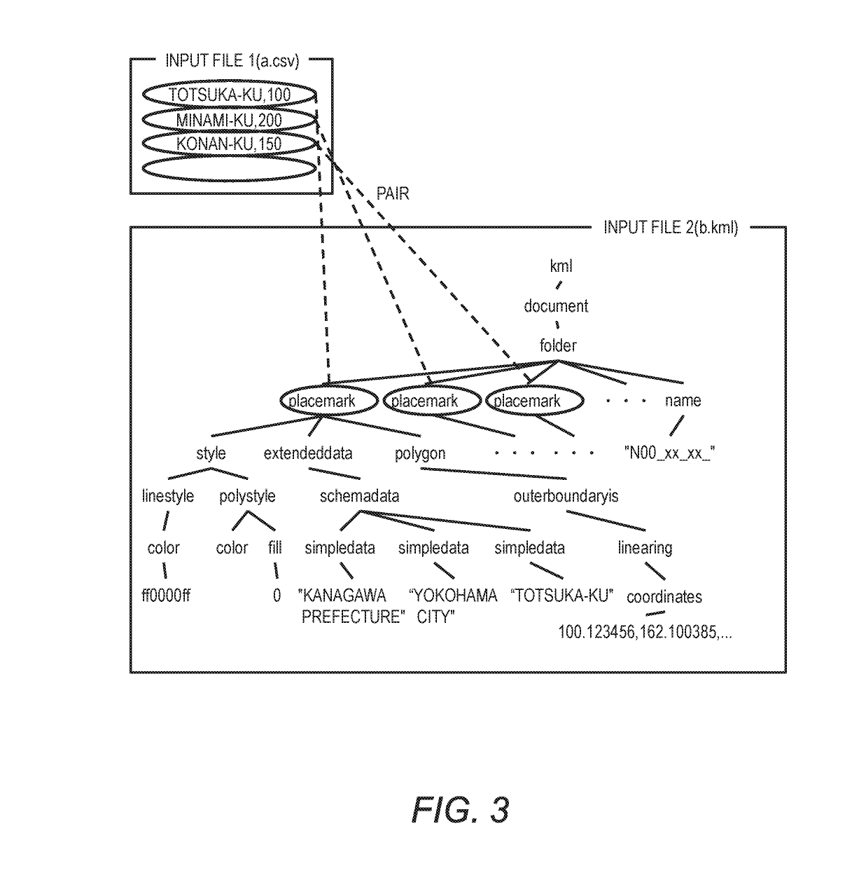

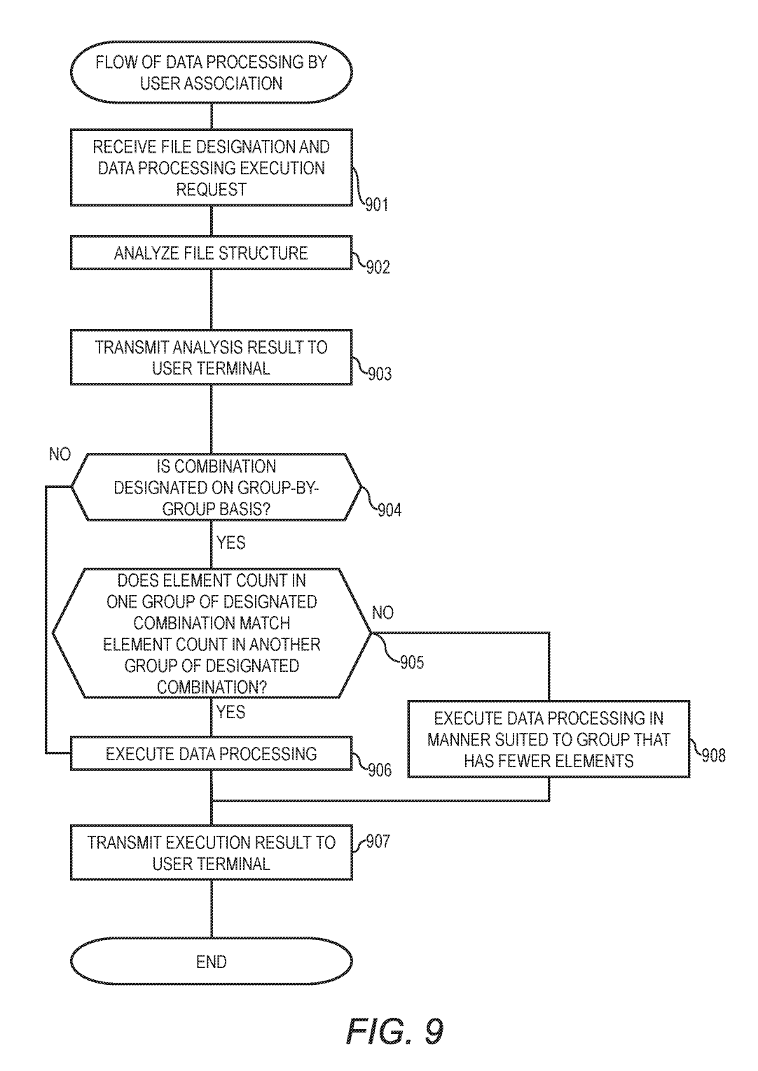

FIG. 9 is a flow chart for illustrating an example of data combining processing based on user association which is executed by the data processing server 101 according to the first embodiment of this invention. First, the CPU 103 of the data processing server 101 receives, from the user, the designation of a file and a request to execute data processing that is related to a particular function (Step 901). The CPU 103 next analyzes the structure of the designated file (Step 902). For example, when the designated file is a file “b.kml” as illustrated in FIG. 3, the CPU 103 checks the contents of the file to find out that the file has a structure illustrated in FIG. 3. The CPU 103 transmits the result of the file structure analysis to the user terminal 121 (Step 903). The result of the file structure analysis is displayed on the display apparatus 125 of the user terminal 121, and the user designates which elements are to be combined with each other. This processing is described by taking FIG. 3 as an example. In the example of FIG. 3, the file “a.csv” and the file “b.kml” are input, and the two files are combined to be processed by the CPU 103 of the data processing server 101. The results of analyzing the structures of the input files are presented to the user on a GUI such as a browser in the form illustrated in FIG. 3, for example. Based on the presented information, the user associates elements that are to be combined with each other. The association may be made by, for example, connecting elements by a line on the GUI. In the example of FIG. 3, an element in each line of the file “a.csv” is associated with a <placemark> element of the file “b.kml”. The designation of element combinations is received from the user in this manner. The user may designate a combination on a one-to-one basis, such as a combination of an element in the first line of “a.csv” and the first <placemark> element of “b.kml”, or may designate on a group-by-group basis, such as a group made up of elements in the respective lines of “a.csv” and a group made up of <placemark> elements of “b.kml”.

The CPU 103 next determines whether or not an element combination designated by the user has been designated on a group-by-group basis (Step 904). In the case where the user has not designated on a group-by-group basis (Step 904: NO), the CPU 103 executes the requested data processing (Step 906), transmits the result of executing the data processing to the user terminal 121 (Step 907), and ends the processing. In the case where the user has designated on a group-by-group basis (Step 904: YES), the CPU 103 determines whether or not the number of elements in one group of the designated combination is the same as the number of elements in another group of the designated combination (Step 905). In the case where the groups have the same number of elements (Step 905: YES), the CPU executes the requested data processing, transmits the result of executing the data processing to the user terminal 121, and ends the processing. In the case where the groups have different numbers of elements (Step 905: NO), the CPU 103 executes the requested data processing in a manner suited to elements that are fewer in number of the compared groups (Step 908), transmits the result of executing the data processing to the user terminal 121, and ends the processing.

The specifics of the data combining processing based on user association have now been described. While a data combination is designated based on association made by the user here, the same may be executed through the flow of the data combination inferring processing described above. In this case, for example, in the case of FIG. 3, the data processing server 101 regards each line of the file “a.csv” as one element and identifies elements of the file “b.kml” that are in the same number as the number of those elements of “a.csv”. The elements of “b.kml” that meet the criterion are <placemark> elements in the example of FIG. 3. The data processing server 101 further determines for each element of “a.csv” which <placemark> element is associated with the element of “a.csv”, and combines the associated pieces of data to process. For example, an element of “a.csv” and a <placemark> element that have a common value are associated with each other. In the example of FIG. 3, the first element of “a.csv” has a value “Totsuka-ku” and the first <placemark> element of “b.kml” has the same value “Totsuka-ku”, and the data processing server 101 accordingly determines that the elements are associated with each other. This association may be made by other methods than the processing method described above, and may be designated by the user.

The data combination candidate registering processing according to the first embodiment of this invention is described next. Data combination candidates registered through this processing can be referred to when the user combines pieces of data from then on.

### <Data Combination Candidate Registering Processing>

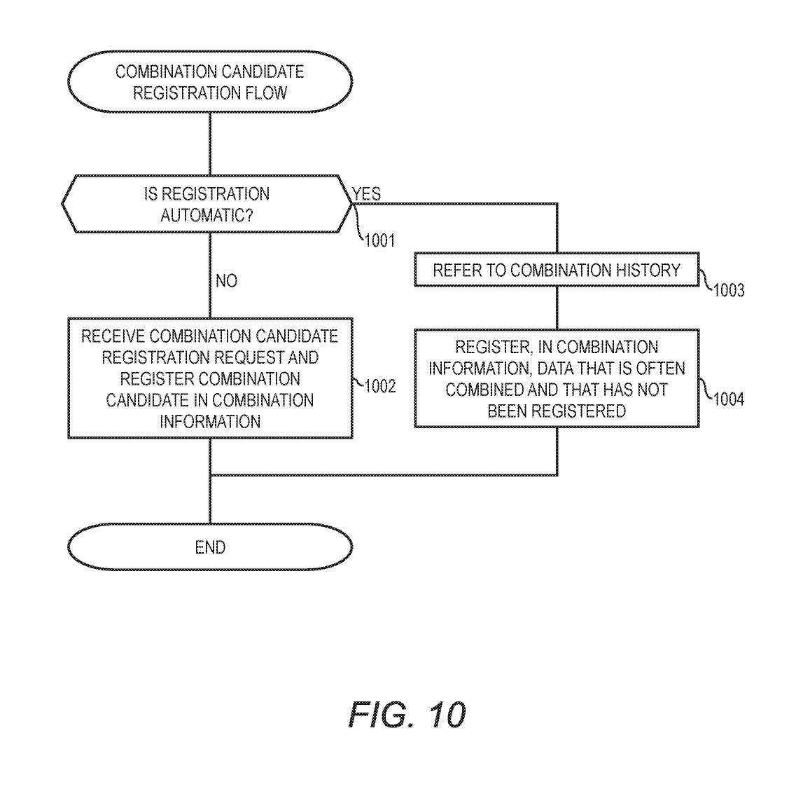

FIG. 10 is a flow chart for illustrating an example of data combination candidate registering processing, which is executed by the data processing server 101 according to the first embodiment of this invention. The CPU 103 of the data processing server 101 determines whether or not the data processing server 101 is set so that combination candidates are registered automatically (Step 1001). For example, modes such as one in which combination candidates are registered automatically to the data processing server 101, one in which combination candidates are registered manually to the data processing server 101 by the user, and one in which automatic registration and manual registration can both be executed are provided, and the CPU 103 may determine whether or not the registration is to be executed automatically based on which mode is set. In the case where automatic registration is not set (Step 1001: NO), the CPU 103 receives a request to register combination candidates from the user terminal 121, and registers candidates designated by the user in the data combination information 111 on the memory 102 (Step 1002). In the case where automatic registration is set (Step 1001: YES), the CPU 103 refers to the combination history information 113 on the memory 102 (Step 1003), and registers in the data combination information 111 on the memory 102 an unregistered combination of pieces of data that are frequently combined (Step 1004). The data processing system may be configured so that, in step 1002, a combination candidate is registered only when data processing where the combination candidate is actually used is executed properly without errors or other troubles. When registering a combination candidate, information about an associated function (in the case where the data processing server 101 has many data processing functions, for example, information indicating for each registered combination candidate which of the data processing functions uses information of the combination candidate) may be registered in addition to information of the combination candidate. Summary information indicating what result is obtained by combining and processing pieces of data may be registered as well.

The related data obtaining processing according to the first embodiment of this invention is described next. There are cases where the specifics of data processing are the same for different combinations of pieces of data. For example, when pieces of data are combined and processed by residents of Yokohama City, residents of Kawasaki City and Yokosuka City may wish to execute the same processing on different data. In anticipation of such possibilities, the data processing server 101 may make the processing into a pattern and manage the pattern to provide the pattern for use by many users and thus improve the convenience of users. To accomplish this, when a user operates the user terminal 121 to execute processing with the use of data of Yokohama City, for example, the data processing server 101 obtains related data (e.g., similar data of Kawasaki City and Yokosuka City) as well in advance to prepare for future inquiries from users about the same processing. The data processing server 101 may also inform users via the user terminal 121 of the option of executing the same processing for, for example, other cities, based on the data obtained in advance. Details of the related data obtaining processing are described below.

### <Related Data Obtaining Processing>

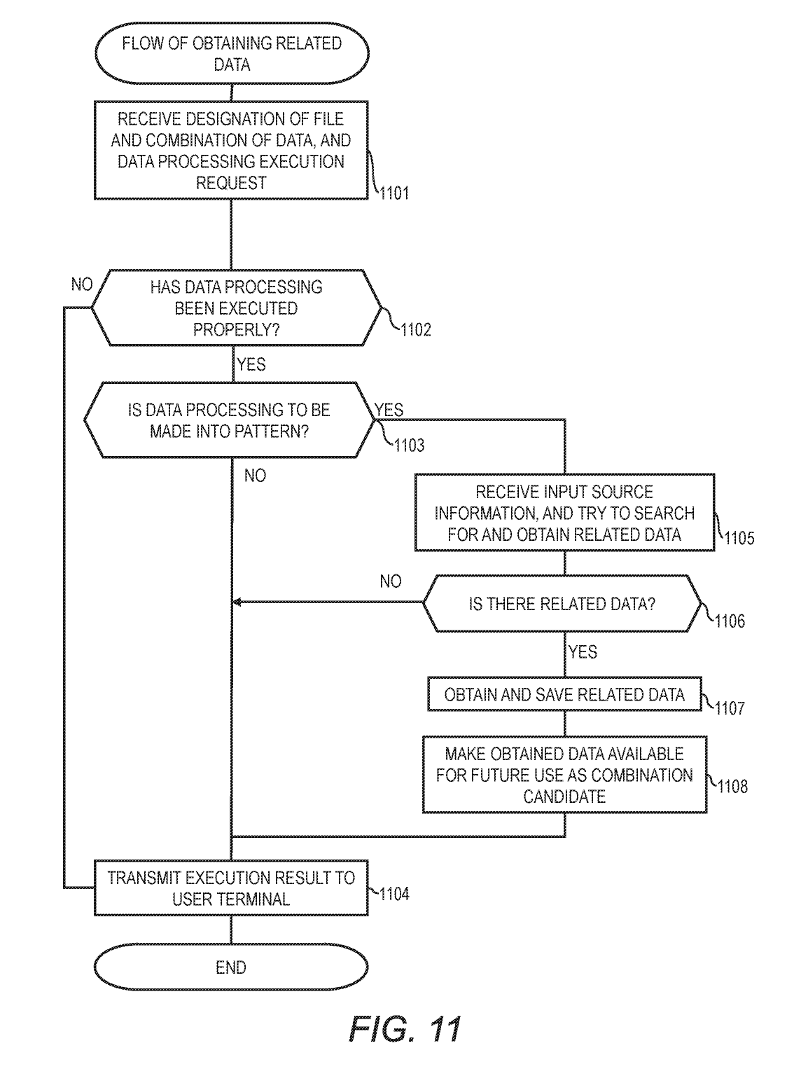

FIG. 11 is a flow chart for illustrating an example of related data obtaining processing, which is executed by the data processing server 101 according to the first embodiment of this invention. The CPU 103 of the data processing server 101 first receives the designation of a file and a combination of pieces of data, and a request to execute data processing that is related to a particular function (Step 1101). The CPU 103 next executes the requested data processing, and determines whether or not the data processing has been executed properly without errors or other troubles (Step 1102). In the case where the data processing has not been executed properly (Step 1102: NO), the CPU 103 transmits this data processing result to the user terminal 121 (Step 1104), and ends the processing. In the case where the data processing has been executed properly (Step 1102: YES), the CPU 103 determines whether to make the data processing requested by the user terminal 121 into a pattern, by, for example, making an inquiry to the user via the user terminal 121 (Step 1103). In the case where the data processing is not to be made into a pattern (Step 1103: NO), the CPU 103 transmits the result of executing the data processing to the user terminal 121 and ends the processing. When it is determined in Step 1103 that the data processing is to be made into a pattern, by, for example, receiving from the user terminal 121 a response to the effect that the data processing is to be made into a pattern which is input to the user terminal 121 by the user operating the user terminal 121, the CPU 103 receives, from the user, input source information about the source of the file and data combination designated in Step 1101. Based on the input source information, the CPU 103 searches for and obtains related data (Step 1105). The related data may be obtained by, for example, receiving input source information such as a URL at which the designated file is published from the user, and obtaining other pieces of data at the URL. For instance, in the case where the file designated by the user is a file “Yokohama_City.csv” and other files such as a file “Yokosuka_City.csv” are located at a URL where this input file is published, the other files are obtained as related data. When obtaining related data, data to be obtained may be filtered by, for example, referring to file name information. For instance, in the case where the file designated by the user is a file “Kanagawa_Prefecture.csv”, the CPU 103 checks whether a file “Tokyo.csv” or similar data is at the location of input source information provided by the user and obtains the found data as related data. In the case where the file designated by the user is the file “Yokohama_City.csv”, the CPU 103 checks whether the file “Kawasaki_City.csv” or similar data is at the location of the input source information, and obtains the found data as related data. Whether or not a piece of data is related data may be determined by, for example, managing the fact that Yokohama City and Kawasaki City are related to each other as Kanagawa Prefecture cities information in the form of dictionary information, and referring to the managed information. The CPU 103 determines whether or not related data has been found as a result of conducting a search for related data in Step 1105 (Step 1106). In the case where related data has not been found (Step 1106: NO), the CPU 103 transmits the result of executing the data processing to the user terminal 121 and ends the processing. In the case where related data has been found (Step 1106: YES), the CPU 103 obtains the related data and saves the obtained data in the memory 102 or other places (Step 1107). The CPU 103 makes the obtained related data available for future use, for example, as data combination candidates to be presented to the user (Step 1108), transmits the result of executing the data processing to the user terminal 121, and ends the processing. When making the data processing into a pattern in Step 1103, processing pattern information indicating what data processing is executed or similar information may be defined in the data processing server 101 to be managed in association with the file designated by the user and with data obtained by the data processing server 101 as related data of the designated file. The processing pattern information may be called up as the need arises, such as when a request is made by the user terminal 121.

The basic data combining processing, the data combination inferring processing, the data combination processing based on user association, the data combination information registering processing, and the related data obtaining processing in the first embodiment have now been described.

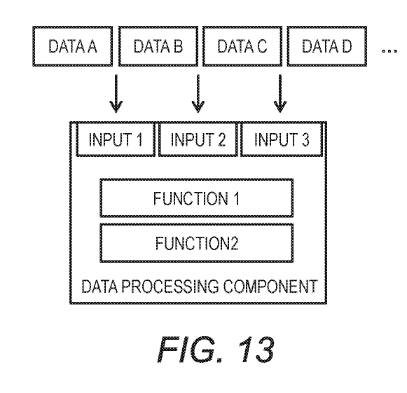

A second embodiment of this invention is described next. The description of the first embodiment has taken as an example a case where data processing by the data processing server 101 is started after the user finishes inputting all files to be designated. In the second embodiment, the data processing server 101 starts the execution of data processing as soon as the use designates one file, instead of waiting for the user to input all files to be designated. The user may designate a file by, for example, using a console, a browser, or the like to designate a file name, or by displaying a data processing component as the one illustrated in FIG. 13 on a Web browser or other browsers and linking the data processing component to a data object that represents data such as a file. In the example of FIG. 13, data A and data B are input to the data processing component by linking data objects of the data A and the data B to the data processing component.

The data combining processing in this embodiment (hereinafter referred to as mid-input data combining processing) is described below. In this processing, as soon as the user inputs one piece of data as designated data, the data processing server 101 determines whether or not the input data is suitable for the execution of a given function, searches for candidates for data that can be combined with the input data, and presents the candidates to the user. This way, in the case where a given piece of input data is to be combined with other pieces of data (other inputs) to be processed by some processing, the data processing server 101 can assist the user in selecting a combination candidate at an earlier stage than in the method where data processing is started after the user finishes inputting all pieces of data to be designated, thereby saving the user the trouble of searching for a combination candidate. The data processing system of this embodiment has the same hardware configuration and software configuration as those in the first embodiment, and descriptions on the configurations are omitted.

### <Mid-input Data Combining Processing>

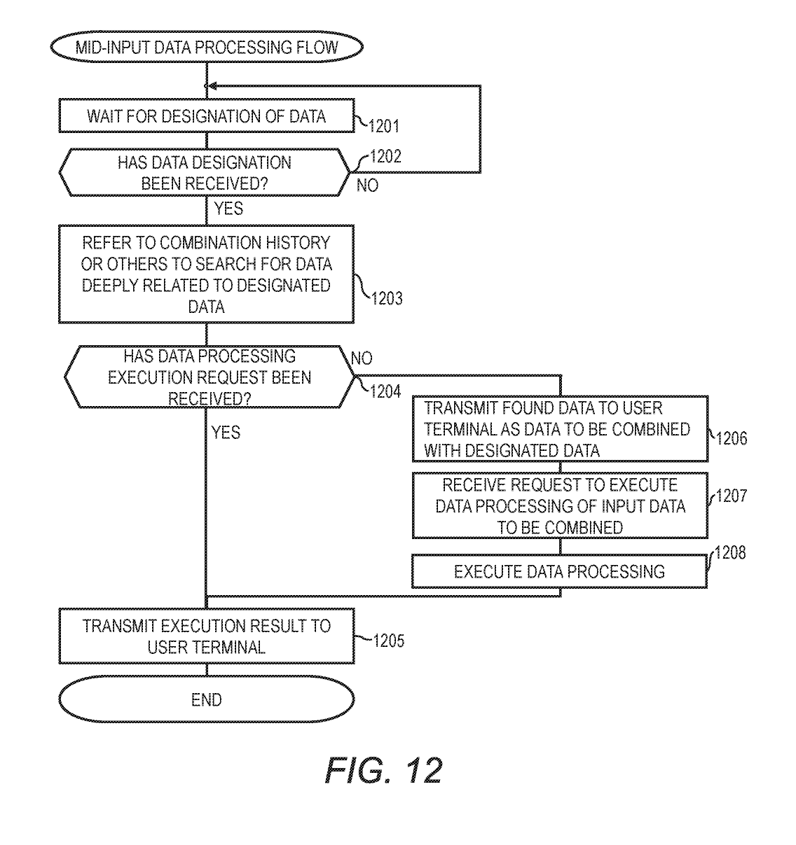

FIG. 12 is a flow chart for illustrating an example of mid-input data combining processing, which is executed by the data processing server 101 according to the second embodiment of this invention. The CPU 103 of the data processing server 101 first stands by until data is designated by the user terminal 121 (Step 1201). The CPU 103 determines whether or not the designation of data has been received (Step 1201). In the case where data designation has not been received (Step 1201: NO), the CPU 103 returns to Step 1201. In the case where data designation has been received (Step 1201: YES), the CPU 103 refers to the combination history information 113 on the memory 102 or similar information to search for data that is considered as being deeply related to the data designated in Step 1202 (Step 1203). For example, the CPU 103 figures out, from the combination history information 113, data which is often used in combination with the designated data, and determines this data as data deeply related to the designated data. To give another example, the CPU 103 may refer to the data combination information 111 on the memory 102 to determine whether or not the designated data is included in the data combination information 111 and, in the case where the designated data has been registered in the data combination information 111, to determine data that is to be combined with the designated data according to the data combination information 111 as data deeply related to the designated data.

The CPU 103 then determines whether or not a data processing execution request has been received from the user terminal 121 (Step 1204). For example, a processing execution button or the like may be provided in a function component as the one illustrated in FIG. 13 to enable the CPU 103 of the data processing server 101 to determine that the execution request has not been received in the case where a press of the execution button has not been detected, and determine that the execution request has been received in the case where a press of the execution button has been detected. In the case where the data processing execution request has been received (Step 1204: YES), the CPU 103 transmits the result of executing the requested data processing to the user terminal 121 (Step 1205), and ends the processing. In the case where the data processing execution request has not been received yet (Step 1204: NO), the CPU 103 transmits the data determined in the search of Step 1203 as data deeply related to the designated data to the user terminal 121 as a candidate for data to be combined with the designated data (Step 1206). The candidate for data to be combined is presented to the user via the display apparatus 125 of the user terminal 121. The processing described above takes into consideration the fact that the data processing server 101 waits long to receive a data processing execution request when, for example, a user who intends to execute some processing with the use of a particular piece of data does not know what other data to combine with this data for the processing. Instead of this processing method in which a candidate for data to be combined with is presented, or not presented, to the user depending on how long it takes to receive a data processing execution request or other factors, an inquiry made by the user about related data may directly be received and responded to via the user terminal 121. For example, the data processing server 101 receives via the user terminal 121 an inquiry made by the user about which data is related to a particular piece of data, or what processing can be executed with the use of a particular piece of data. In response to the inquiry, the data processing server 101 obtains related data or options for processing that can be executed with the use of the particular piece of data, based on the past combination history information 113 and the data combination information 111, and presents the related data or the options via the user terminal 121 for the user to select from.

When the user selects and inputs data to be combined with the designated data from among candidates presented in Step 1206, the CPU 103 then receives, from the user terminal 121, a request to execute data processing for the data to be combined which has been selected and input by the user (Step 1207), executes the requested data processing (Step 1208), transmits the result of executing the data processing to the user terminal 121, and ends the processing.

The second embodiment of this invention has now been described.

According to the embodiments of this invention described above, in a data processing system including, for example, a data processing server and a user terminal, the data processing server includes data combination information, which is information about combinations of pieces of data, data source information, which is information about sources from which published data is obtained, combination history information, which is history information about data combining processing that was executed in the past by the data processing server, and file information, which is information about files and other types of data that are kept on the data processing server.

Based on files that are input by a user and an operation request that is made by the user, the data processing server analyzes the input files, counts the number of elements for each element type in each input file, and determines whether or not one input file and another input file have the same number of identical or different elements. In the case where the input files have the same number of elements, the data processing server determines whether there are many candidates for a combination of such elements. In the case where there are many candidates, the data processing server presents the candidates to the user, and executes data processing based on a combination that is selected by the user. The data processing server also infers a candidate for data to be combined with designated data based on the combination history information or other types of information. The data processing server allows the user to designate a data combination by, besides selecting from data combination candidates, associating one element with another element based on the result of analyzing the structures of the input files. In another mode of the data processing server, the data processing server stands by until the designation of an input file is received from the user and, as soon as one designated file is input, refers to the combination history information or other types of information to search for data that is deeply related to the input designated file. In the case where the user has not made an operation request yet, the data processing server presents to the user the data determined as being deeply related to the input designated file, and executes data processing based on related data that is selected by the user.

According to the embodiments of this invention, pieces of data from files that have dissimilar file structures or from files that have different formats can thus be combined in an appropriate manner for processing. In addition, this invention facilitates processing of a combination of pieces of data even for users with little knowledge in how pieces of data are to be combined, by presenting candidates for a data combination and other measures. For users who have a certain degree of knowledge in data structures and how pieces of data are to be combined, on the other hand, this invention allows the users to customize data combinations more freely.

The embodiments of this invention are described above, but this invention is by no means limited to those embodiments. It should be understood that this invention may be carried out in various modes without departing from the spirit of this invention.

### EXPLANATION OF REFERENCE NUMERALS

101 data processing server, 102 and 122 memory, 103 and 124 CPU, 104 and 123 I/F, 105 function executing module, 106 data combination management module, 107 data analyzing module, 108 data obtaining module, 109 data converting module, 110 user cooperation module, 111 data combination information, 112 data source information, 113 combination history information, 114 file information, 121 user terminal, 125 display apparatus, 126 server cooperation module, 127 user cooperation module, 141 data publishing server

What is claimed is:

1. A data processing server, comprising:
a memory unit configured to store a plurality of files; and
a processor configured to:
receive, from a user terminal, designation of a first file and a second file, and a request to execute data processing that is related to a particular function;
obtain the designated first file and the designated second file from the memory unit;
analyze structures of the obtained first file and the obtained second file;
combine, when there is a first element set in the first file as many elements as in a second element set the second file has, the elements of the first element set with the elements of the second element set to execute the data processing; and
transmit a result of executing the data processing to the user terminal.

2. The data processing server according to claim 1, wherein, when each element set in a first group, which is comprised of a plurality of element sets and is included in the first file, has as many elements as an element set in a second group, which is comprised of a plurality of element sets and is included in the second file, has, the processor is configured to transmit each combination of an element set in the first group and an element set in the second group which have a same number of elements as combination candidate information, receive designation of a combination candidate from the user terminal, combine the elements of the designated combination candidate to each other, and execute the data processing.

3. The data processing server according to claim 1,
wherein the memory unit is configured to further store data combination history information, and
wherein, when the designation of a file and the data processing execution request are received from the user terminal, the processor is configured to determine whether or not there are files that are often combined with the designated file by referring to the combination history information of the memory unit, transmit, when such file combinations are found, the found file combinations to the user terminal as combination candidates, receive designation of a combination candidate from the user terminal, and execute the data processing by combining an element of one file in the designated file combination with an element of another file in the designated file combination.

4. The data processing server according to claim 3, wherein the processor is configured to receive the designation of a combination candidate from the user terminal, determine whether or not one file and another file in the designated file combination have the same number of elements, execute the data processing by combining the elements with each other when the files have the same number of elements, and, when the files have different numbers of elements, execute the data processing by combining all elements of the file that is lower in element count with a number of elements of the file higher in element count that matches the lower element count.

5. The data processing server according to claim 1, wherein the processor is configured to execute the requested data processing, determine whether or not the data processing has been executed properly, receive, when the data processing has been executed properly, an instruction to make the data processing into a pattern from the user terminal, receive, from the user terminal, source information of the designated first file and the designated second file, obtain data related to the first file and data related to the second file based on the source information, and transmit the obtained data to the user terminal as combination candidates.

6. The data processing server according to claim 3, wherein the processor is configured to receive the designation of a file, refer to the combination history information, identify files that are often combined with the designated file in the combination history information, determine whether or not the identified file combinations include files that are related to the designated file, determine, when the related files are found, the found files as files that are deeply related to the designated file, transmit the deeply related files to the user terminal as candidates for a file to be combined with the designated file, receive designation of a combination candidate from the user terminal, and execute the data processing by combining an element of one file in the designated file combination with an element of another file in the designated file combination.

7. A data processing method to be performed by a data processing server coupled to a user terminal, comprising:
receiving, from the user terminal, designation of a first file and a second file, and a request to execute data processing that is related to a particular function;
obtaining the designated first file and the designated second file from a memory unit;
analyzing structures of the obtained first file and the obtained second file;
combining, when there is a first element set in the first file as many elements as in a second element set the second file has, the elements of the first element set with the elements of the second element set to execute the data processing; and
transmitting a result of executing the data processing to the user terminal.

8. The data processing method according to claim 7, further comprising transmitting, when each element set in a first group, which is comprised of a plurality of element sets and is included in the first file, has as many elements as an element set in a second group, which is comprised of a plurality of element sets and is included in the second file, has, each combination of an element set in the first group and an element set in the second group which have a same number of elements to the user terminal as combination candidate information, receiving designation of a combination candidate from the user terminal, combining the elements of the designated combination candidate to each other, and executing the data processing.

9. The data processing method according to claim 7, further comprising determining, when the designation of a file and the data processing execution request are received from the user terminal, whether or not there are files that are often combined with the designated file by referring to combination history information stored in the memory unit, transmitting, when such file combinations are found, the found file combinations to the user terminal as combination candidates, receiving designation of a combination candidate from the user terminal, and executing the data processing by combining an element of one file in the designated file combination with an element of another file in the designated file combination.

10. The data processing method according to claim 9, further comprising receiving the designation of a combination candidate from the user terminal, determining whether or not one file and another file in the designated file combination have the same number of elements, executing the data processing by combining the elements with each other when the files have the same number of elements, and, when the files have different numbers of elements, executing the data processing by combining all elements of the file that is lower in element count with a number of elements of the file higher in element count that matches the lower element count.

11. The data processing method according to claim 7, further comprising executing the requested data processing, determining whether or not the data processing has been executed properly, receiving, when the data processing has been executed properly, an instruction to make the data processing into a pattern from the user terminal, receiving, from the user terminal, source information of the designated first file and the designated second file, obtaining data related to the first file and data related to the second file based on the source information, and transmitting the obtained data to the user terminal as combination candidates.

12. The data processing method according to claim 9, further comprising receiving the designation of a file, referring to the combination history information, identifying files that are often combined with the designated file in the combination history information, determining whether or not the identified file combinations include files that are related to the designated file, determining, when the related files are found, the found files as files that are deeply related to the designated file, transmitting the deeply related files to the user terminal as candidates for a file to be combined with the designated file, receiving designation of a combination candidate from the user terminal, and executing the data processing by combining an element of one file in the designated file combination with an element of another file in the designated file combination.
